(19) United States
(12) Patent Application Publication
(10) Pub. No.: US 2016/0165341 A1
(43) Pub. Date: Jun. 9, 2016

(54) PORTABLE MICROPHONE ARRAY

(71) Applicant: STAGES PCS, LLC, Princeton, NJ (US)

(72) Inventor: Benjamin D. Benattar, Cranbury, NJ (US)

(73) Assignee: STAGES PCS, LLC, Ewing, NJ (US)

(21) Appl. No.: 14/960,110

(22) Filed: Dec. 4, 2015

Related U.S. Application Data
(63) Continuation-in-part of application No. 14/561,972, filed on Dec. 5, 2014.
Application No. 14/561,972 is a continuation-in-part of application No. 14/827,315, filed on Aug. 15, 2015.
Application No. 14/827,315 is a continuation-in-part of application No. 14/827,316, filed on Aug. 15, 2015.
Application No. 14/827,316 is a continuation-in-part of application No. 14/827,317, filed on Aug. 15, 2015.
Application No. 14/827,317 is a continuation-in-part of application No. 14/827,319, filed on Aug. 15, 2015.
Application No. 14/827,319 is a continuation-in-part of application No. 14/827,320, filed on Aug. 15, 2015.
Application No. 14/827,320 is a continuation-in-part of application No. 14/827,322, filed on Aug. 15, 2015.

(51) Int. Cl. H04R 1/40; G01S 3/80

(52) U.S. Cl. CPC H04R 1/406; G01S 3/8006; H04R 2201/405

(57) ABSTRACT

A microphone array of three or more microphones may be mounted on a housing or substrate configured to be part of a smartphone or a smartphone protective case. The microphone array may be positioned so that the far field sensing range of the microphone array is unobstructed. The microphone array may be utilized with a beam-forming system in order to determine location of an audio source and a beam-steering system in order to isolate audio emanating from the direction of the audio source. The beam-forming system may be suitable for tracking the movement of one or more audio sources in order to inform the beam-steering system of the direction or location to be isolated.

### CROSS REFERENCE TO RELATED APPLICATIONS

This application is a continuation-in-part of and claims priority and the benefit of the filing dates of co-pending U.S. patent application Ser. No. 14/561,972 filed Dec. 5, 2014, U.S. Pat. No. ______ and its continuation-in-part applications U.S. patent application Ser. No. 14/827,315 (Attorney Docket Number 111003); Ser. No. 14/827,316 (Attorney Docket Number 111004); Ser. No. 14/827,317 (Attorney Docket Number 111007); Ser. No. 14/827,319 (Attorney Docket Number 111008); Ser. No. 14/827,320 (Attorney Docket Number 111009); Ser. No. 14/827,322 (Attorney Docket Number 111010), filed on Aug. 15, 2015, all of which are hereby incorporated by reference as if fully set forth herein. This application is related to U.S. patent application Ser. No. ______ (Attorney Docket Number 111013); U.S. patent application Ser. No. ______ (Attorney Docket Number 111014); U.S. patent application Ser. No. ______ (Attorney Docket Number 111015); U.S. patent application Ser. No. ______ (Attorney Docket Number 111016); U.S. patent application Ser. No. ______ (Attorney Docket Number 111017); U.S. patent application Ser. No. ______ (Attorney Docket Number 111018); U.S. patent application Ser. No. ______ (Attorney Docket Number 111019); and U.S. patent application Ser. No. ______ (Attorney Docket Number 111020), all filed on even date herewith, all of which are hereby incorporated by reference as if fully set forth herein.

### BACKGROUND OF THE INVENTION

1. Field of the Invention

The invention relates to microphone arrays and particularly to a portable microphone array.

2. Description of the Related Technology

A microphone is an acoustic-to-electric transducer or sensor that converts sound into an electrical signal. Personal audio is typically delivered to a user by headphones. Headphones are a pair of small speakers that are designed to be held in place close to a user's ears. They may be electroacoustic transducers which convert an electrical signal to a corresponding sound in the user's ear. Headphones are designed to allow a single user to listen to an audio source privately, in contrast to a loudspeaker which emits sound into the open air, allowing anyone nearby to listen. Earbuds or earphones are in-ear versions of headphones. Personal audio is often delivered from a player integrated in a personal computing device such as a smartphone.

A sensitive transducer element of a microphone is called its element or capsule. Except in thermophone based microphones, sound is first converted to mechanical motion by means of a diaphragm, the motion of which is then converted to an electrical signal. A complete microphone also includes a housing, some means of bringing the signal from the element to other equipment, and often an electronic circuit to adapt the output of the capsule to the equipment being driven. A wireless microphone contains a radio transmitter.

The condenser microphone, is also called a capacitor microphone or electrostatic microphone. Here, the diaphragm acts as one plate of a capacitor, and the vibrations produce changes in the distance between the plates.

A fiber optic microphone converts acoustic waves into electrical signals by sensing changes in light intensity, instead of sensing changes in capacitance or magnetic fields as with conventional microphones. During operation, light from a laser source travels through an optical fiber to illuminate the surface of a reflective diaphragm. Sound vibrations of the diaphragm modulate the intensity of light reflecting off the diaphragm in a specific direction. The modulated light is then transmitted over a second optical fiber to a photo detector, which transforms the intensity-modulated light into analog or digital audio for transmission or recording. Fiber optic microphones possess high dynamic and frequency range, similar to the best high fidelity conventional microphones. Fiber optic microphones do not react to or influence any electrical, magnetic, electrostatic or radioactive fields (this is called EMI/RFI immunity). The fiber optic microphone design is therefore ideal for use in areas where conventional microphones are ineffective or dangerous, such as inside industrial turbines or in magnetic resonance imaging (MRI) equipment environments.

Fiber optic microphones are robust, resistant to environmental changes in heat and moisture, and can be produced for any directionality or impedance matching. The distance between the microphone's light source and its photo detector may be up to several kilometers without need for any preamplifier or other electrical device, making fiber optic microphones suitable for industrial and surveillance acoustic monitoring. Fiber optic microphones are suitable for use application areas such as for infrasound monitoring and noise-canceling.

U.S. Pat. No. 6,462,808 B2, the disclosure of which is incorporated by reference herein shows a small optical microphone/sensor for measuring distances to, and/or physical properties of, a reflective surface

The MEMS (MicroElectrical-Mechanical System) microphone is also called a microphone chip or silicon microphone. A pressure-sensitive diaphragm is etched directly into a silicon wafer by MEMS processing techniques, and is usually accompanied with integrated preamplifier. Most MEMS microphones are variants of the condenser microphone design. Digital MEMS microphones have built in analog-to-digital converter (ADC) circuits on the same CMOS chip making the chip a digital microphone and so more readily integrated with modern digital products. Major manufacturers producing MEMS silicon microphones are Wolfson Microelectronics (WM7xxx), Analog Devices, Akustica (AKU200x), Infineon (SMM310 product), Knowles Electronics, Memstech (MSMx), NXP Semiconductors, Sonion MEMS, Vesper, AAC Acoustic Technologies, and Omron.

A microphone's directionality or polar pattern indicates how sensitive it is to sounds arriving at different angles about its central axis. The polar pattern represents the locus of points that produce the same signal level output in the microphone if a given sound pressure level (SPL) is generated from that point. How the physical body of the microphone is oriented relative to the diagrams depends on the microphone design. Large-membrane microphones are often known as “side fire” or “side address” on the basis of the sideward orientation of their directionality. Small diaphragm microphones are commonly known as “end fire” or “top/end address” on the basis of the orientation of their directionality.

Some microphone designs combine several principles in creating the desired polar pattern. This ranges from shielding (meaning diffraction/dissipation/absorption) by the housing itself to electronically combining dual membranes.

An omni-directional (or non-directional) microphone's response is generally considered to be a perfect sphere in three dimensions. In the real world, this is not the case. As with directional microphones, the polar pattern for an “omni-directional” microphone is a function of frequency. The body of the microphone is not infinitely small and, as a consequence, it tends to get in its own way with respect to sounds arriving from the rear, causing a slight flattening of the polar response. This flattening increases as the diameter of the microphone (assuming it's cylindrical) reaches the wavelength of the frequency in question.

A unidirectional microphone is sensitive to sounds from only one direction.

A noise-canceling microphone is a highly directional design intended for noisy environments. One such use is in aircraft cockpits where they are normally installed as boom microphones on headsets. Another use is in live event support on loud concert stages for vocalists involved with live performances. Many noise-canceling microphones combine signals received from two diaphragms that are in opposite electrical polarity or are processed electronically. In dual diaphragm designs, the main diaphragm is mounted closest to the intended source and the second is positioned farther away from the source so that it can pick up environmental sounds to be subtracted from the main diaphragm's signal. After the two signals have been combined, sounds other than the intended source are greatly reduced, substantially increasing intelligibility. Other noise-canceling designs use one diaphragm that is affected by ports open to the sides and rear of the microphone.

Sensitivity indicates how well the microphone converts acoustic pressure to output voltage. A high sensitivity microphone creates more voltage and so needs less amplification at the mixer or recording device. This is a practical concern but is not directly an indication of the microphone's quality, and in fact the term sensitivity is something of a misnomer, “transduction gain” being perhaps more meaningful, (or just “output level”) because true sensitivity is generally set by the noise floor, and too much “sensitivity” in terms of output level compromises the clipping level.

A microphone array is any number of microphones operating in tandem. Microphone arrays may be used in systems for extracting voice input from ambient noise (notably telephones, speech recognition systems, and hearing aids), surround sound and related technologies, binaural recording, locating objects by sound: acoustic source localization, e.g., military use to locate the source(s) of artillery fire, aircraft location and tracking.

Typically, an array is made up of omni-directional microphones, directional microphones, or a mix of omni-directional and directional microphones distributed about the perimeter of a space, linked to a computer that records and interprets the results into a coherent form. Arrays may also be formed using numbers of very closely spaced microphones. Given a fixed physical relationship in space between the different individual microphone transducer array elements, simultaneous DSP (digital signal processor) processing of the signals from each of the individual microphone array elements can create one or more “virtual” microphones.

Beamforming or spatial filtering is a signal processing technique used in sensor arrays for directional signal transmission or reception. This is achieved by combining elements in a phased array in such a way that signals at particular angles experience constructive interference while others experience destructive interference. A phased array is an array of antennas, microphones or other sensors in which the relative phases of respective signals are set in such a way that the effective radiation pattern is reinforced in a desired direction and suppressed in undesired directions. The phase relationship may be adjusted for beam steering. Beamforming can be used at both the transmitting and receiving ends in order to achieve spatial selectivity. The improvement compared with omni-directional reception/transmission is known as the receive/transmit gain (or loss).

Adaptive beamforming is used to detect and estimate a signal-of-interest at the output of a sensor array by means of optimal (e.g., least-squares) spatial filtering and interference rejection.

To change the directionality of the array when transmitting, a beamformer controls the phase and relative amplitude of the signal at each transmitter, in order to create a pattern of constructive and destructive interference in the wavefront. When receiving, information from different sensors is combined in a way where the expected pattern of radiation is preferentially observed.

With narrow-band systems the time delay is equivalent to a “phase shift”, so in the case of a sensor array, each sensor output is shifted a slightly different amount. This is called a phased array. A narrow band system, typical of radars or small microphone arrays, is one where the bandwidth is only a small fraction of the center frequency. With wide band systems this approximation no longer holds, which is typical in sonars.

In the receive beamformer the signal from each sensor may be amplified by a different “weight.” Different weighting patterns (e.g., Dolph-Chebyshev) can be used to achieve the desired sensitivity patterns. A main lobe is produced together with nulls and side lobes. As well as controlling the main lobe width (the beam) and the side lobe levels, the position of a null can be controlled. This is useful to ignore noise or jammers in one particular direction, while listening for events in other directions. A similar result can be obtained on transmission.

Beamforming techniques can be broadly divided into two categories:

a. conventional (fixed or switched beam) beamformers

b. adaptive beamformers or phased array
i. desired signal maximization mode
ii. interference signal minimization or cancellation mode

Conventional beamformers use a fixed set of weightings and time-delays (or phasings) to combine the signals from the sensors in the array, primarily using only information about the location of the sensors in space and the wave directions of interest. In contrast, adaptive beamforming techniques generally combine this information with properties of the signals actually received by the array, typically to improve rejection of unwanted signals from other directions. This process may be carried out in either the time or the frequency domain.

As the name indicates, an adaptive beamformer is able to automatically adapt its response to different situations. Some criterion has to be set up to allow the adaption to proceed such as minimizing the total noise output. Because of the variation of noise with frequency, in wide band systems it may be desirable to carry out the process in the frequency domain.

Beamforming can be computationally intensive.

Beamforming can be used to try to extract sound sources in a room, such as multiple speakers in the cocktail party problem. This requires the locations of the speakers to be known in advance, for example by using the time of arrival from the sources to mics in the array, and inferring the locations from the distances.

A Primer on Digital Beamforming by Toby Haynes, Mar. 26, 1998 http://www.spectrumsignal.com/publications/beamform_primer.pdf describes beam forming technology.

According to U.S. Pat. No. 5,581,620, the disclosure of which is incorporated by reference herein, many communication systems, such as radar systems, sonar systems and microphone arrays, use beamforming to enhance the reception of signals. In contrast to conventional communication systems that do not discriminate between signals based on the position of the signal source, beamforming systems are characterized by the capability of enhancing the reception of signals generated from sources at specific locations relative to the system.

Generally, beamforming systems include an array of spatially distributed sensor elements, such as antennas, sonar phones or microphones, and a data processing system for combining signals detected by the array. The data processor combines the signals to enhance the reception of signals from sources located at select locations relative to the sensor elements. Essentially, the data processor “aims” the sensor array in the direction of the signal source. For example, a linear microphone array uses two or more microphones to pick up the voice of a talker. Because one microphone is closer to the talker than the other microphone, there is a slight time delay between the two microphones. The data processor adds a time delay to the nearest microphone to coordinate these two microphones. By compensating for this time delay, the beamforming system enhances the reception of signals from the direction of the talker, and essentially aims the microphones at the talker.

A beamforming apparatus may connect to an array of sensors, e.g. microphones that can detect signals generated from a signal source, such as the voice of a talker. The sensors can be spatially distributed in a linear, a two-dimensional array or a three-dimensional array, with a uniform or non-uniform spacing between sensors. A linear array is useful for an application where the sensor array is mounted on a wall or a podium talker is then free to move about a half-plane with an edge defined by the location of the array. Each sensor detects the voice audio signals of the talker and generates electrical response signals that represent these audio signals. An adaptive beamforming apparatus provides a signal processor that can dynamically determine the relative time delay between each of the audio signals detected by the sensors. Further, a signal processor may include a phase alignment element that uses the time delays to align the frequency components of the audio signals. The signal processor has a summation element that adds together the aligned audio signals to increase the quality of the desired audio source while simultaneously attenuating sources having different delays relative to the sensor array. Because the relative time delays for a signal relate to the position of the signal source relative to the sensor array, the beamforming apparatus provides, in one aspect, a system that “aims” the sensor array at the talker to enhance the reception of signals generated at the location of the talker and to diminish the energy of signals generated at locations different from that of the desired talker's location. The practical application of a linear array is limited to situations which are either in a half plane or where knowledge of the direction to the source in not critical. The addition of a third sensor that is not co-linear with the first two sensors is sufficient to define a planar direction, also known as azimuth. Three sensors do not provide sufficient information to determine elevation of a signal source. At least a fourth sensor, not co-planar with the first three sensors is required to obtain sufficient information to determine a location in a three dimensional space.

Although these systems work well if the position of the signal source is precisely known, the effectiveness of these systems drops off dramatically and computational resources required increases dramatically with slight errors in the estimated positional information. For instance, in some systems with source-location schemes, it has been shown that the data processor must know the location of the source within a few centimeters to enhance the reception of signals. Therefore, these systems require precise knowledge of the position of the source, and precise knowledge of the position of the sensors. As a consequence, these systems require both that the sensor elements in the array have a known and static spatial distribution and that the signal source remains stationary relative to the sensor array. Furthermore, these beamforming systems require a first step for determining the talker position and a second step for aiming the sensor array based on the expected position of the talker.

A change in the position and orientation of the sensor can result in the aforementioned dramatic effects even if the talker is not moving due to the change in relative position and orientation due to movement of the arrays. Knowledge of any change in the location and orientation of the array can compensate for the increase in computational resources and decrease in effectiveness of the location determination and sound isolation. An accelerometer is a device that measures acceleration of an object rigidly inked to the accelerometer. The acceleration and timing can be used to determine a change in location and orientation of an object linked to the accelerometer.

### SUMMARY OF THE INVENTION

It is an object to provide a directionally discriminating acoustic sensor.

It is an object to provide a directionally discriminating acoustic sensor in the form a location sensing microphone array.

It is an object to provide an audio sensor array able to isolate an audio source in two or three-dimensional space.

It is an object to provide an audio sensor array that may be connected to or integrated with headphones.

It is an object to provide a microphone array suitable for sensing audio information sufficient for determination of the location of an audio source in a three-dimensional space.

It is an object to work with an audio customization system to enhance a user's audio environment. One type of enhancement would allow a user to wear headphones and specify what ambient audio and source audio will be transmitted to the headphones. Added enhancements may include the display of an image representing the location of one or more audio sources referenced to a user, an audio source, or other location and/or the ability to select one or more of the sources and to record audio in the direction of the selected source(s). The system may take advantage of an ability to identify the location of an acoustic source or a directionally discriminating acoustic sensor, track an acoustic source, isolate acoustic signals based on location, source and/or nature of the acoustic signal, and identify an acoustic source. In addition, ultrasound may be serve as an acoustic source and communication medium.

In order to provide an enhanced experience to the users a source location identification unit may use beamforming in cooperation with a directionally discriminating acoustic sensor to identify the location of an audio source. The location of a source may be accomplished in a wide-scanning mode to identify the vicinity or general direction of an audio source with respect to a directionally discriminating acoustic sensor and/or in a narrow scanning mode to pinpoint an acoustic source. A source location unit may cooperate with a location table that stores a wide location of an identified source and a “pinpoint” location. Because narrow location is computationally intensive, the scope of a narrow location scan can be limited to the vicinity of sources identified in a wide location scan. The source location unit may perform the wide source location scan and the narrow source location scan on different schedules. The narrow source location scan may be performed on a more frequent schedule so that audio emanating from pinpoint locations may be processed for further use.

The location table may be updated in order to reduce the processing required to accomplish the pinpoint scans. The location table may be adjusted by adding a location compensation dependent on changes in position and orientation of the directionally discriminating acoustic sensor. In order to adjust the locations for changes in position and orientation of the sensor array, a motion sensor, for example, an accelerometer, gyroscope, and/or manometer, may be rigidly linked to the directionally discriminating sensor, which may be implemented as a microphone array. Detected motion of the sensor may be used for motion compensation. In this way the narrow source location can update the relative location of sources based on motion of the sensor arrays. The location table may also be updated on the basis of trajectory. If over time an audio source presents from different locations based on motion of the audio source, the differences may be utilized to predict additional motion and the location table can be updated on the basis of predicted source location movement. The location table may track one or more audio sources.

The locations stored in the location table may be utilized by a beam-steering unit to focus the sensor array on the locations and to capture isolated audio from the specified location. The location table may be utilized to control the schedule of the beam steering unit on the basis of analysis of the audio from each of the tracked sources.

Audio obtained from each tracked source may undergo an identification process. An identification process is described in more detail in U.S. patent application Ser. No. 14/827,320 filed Aug. 15, 2015, the disclosure of which is incorporated herein by reference. The audio may be processed through a multi-channel and/or multi-domain process in order to characterize the audio and a rule set may be applied to the characteristics in order to ascertain treatment of audio from the particular source. Multi-channel and multi-domain processing can be computationally intensive. The result of the multi-channel/multi-domain processing that most closely fits a rule will indicate the processing. If the rule indicates that the source is of interest, the pinpoint location table may be updated and the scanning schedule may be set. Certain audio may justify higher frequency scanning and capture than other audio. For example speech or music of interest may be sampled at a higher frequency than an alarm or a siren of interest.

Computational resources may be conserved in some situations. Some audio information may be more easily characterized and identified than other audio information. For example, the aforementioned siren may be relatively uniform and easy to identify. A gross characterization process may be utilized in order to identify audio sources which do not require computationally intense processing of the multi-channel/multi-domain processing unit. If a gross characterization is performed a ruleset may be applied to the gross characterization in order to indicate whether audio from the source should be ignored, should be isolated based on the gross characterization alone, or should be subjected to the multi-channel/multi-domain computationally intense processing. The location table may be updated on the basis of the result of the gross characterization.

In this way the computationally intensive functions may be driven by a location table and the location table settings may operate to conserve computational resources required. The wide area source location may be used to add sources to the source location table at a relatively lower frequency than needed for user consumption of the audio. Successive processing iterations may update the location table to reduce the number of sources being tracked with a pinpoint scan, to predict the location of the sources to be tracked with a pinpoint scan to reduce the number of locations that are isolated by the beam-steering unit and reduce the processing required for the multi-channel/multi-domain analysis.

The ability to determine distance and direction of an audio source is related to the accuracy of the sensors, the accuracy of the processing, and the distance between sensors. Three or more microphones may be mounted on a base. A first microphone may be mounted in a position that is not co-linear with a second microphone and a third microphone. The microphones may be mounted on a base in a configuration where for every angle of azimuth referenced from said microphone array from 0 to 360 degrees, there are at least two microphones which include the angle of azimuth within their field of sensitivity and are unobstructed by the base. A fourth microphone may be mounted in a location that is not co-planar with the first microphone, the second microphone and the third microphone. The base may be a smartphone or a smartphone case. According to a particular embodiment, a fourth microphone may be mounted on an ear speaker housing or an arm band. A fifth microphone may be mounted on an aerial or pivoting arm. The microphone elements may be covered with an acoustic foam for protection.

A beam-forming unit may be responsive to the microphone array. A location compensation signal may be generated by the location processor, and a beam steering unit may be responsive to the microphone array and the location compensation signal generated by the location processor.

A microphone array may be provided having a base associated with a mobile computing device. Three or more microphones may be mounted on the base. The microphones may be mounted in a configuration with a first microphone mounted in apposition that is not co-linear with a second microphone and a third microphone. A fourth microphone may be mounted in a location that is not coplanar with the first microphone, the second microphone, and the third microphone.

The microphones may be mounted on the base in a configuration where, for every angle of azimuth referenced from said microphone array from 0 degrees to 360 degrees, there are at least two microphones in the array which include the angle of azimuth within their field of sensitivity and are unobstructed by the base and user. The base may be an outer housing of the mobile computing device. The base may be a protective case configured to receive a mobile computing device.

An auxiliary power supply may be mounted in the protective case. The auxiliary power supply may be a detachable module mating with a housing of the protective case. The microphones may be mounted in said detachable module. The microphones may be mounted in a generally coplanar configuration. The microphone array may include an additional microphone mounted on a boom configured to position the microphone so that it is not coplanar with the three or more microphones. The boom may be pivot mounted on the base. The additional microphone is mounted on a telescoping boom.

The microphone array may have three or more legs pivot-mounted on the base. The microphone array may include a resilient material mounted on the legs. The resilient material may be vibration damping.

The microphone array may be utilized as part of an audio source location tracking and isolation system. The location processor may be responsive to the microphone array, a beam-forming unit responsive the microphone array, and a beam steering unit responsive to the microphone array

Various objects, features, aspects, and advantages of the present invention will become more apparent from the following detailed description of preferred embodiments of the invention, along with the accompanying drawings in which like numerals represent like components.

Moreover, the above objects and advantages of the invention are illustrative, and not exhaustive, of those that can be achieved by the invention. Thus, these and other objects and advantages of the invention will be apparent from the description herein, both as embodied herein and as modified in view of any variations which will be apparent to those skilled in the art.

### BRIEF DESCRIPTION OF THE DRAWINGS

FIG. 1 shows a smartphone with an integrated microphone.

FIG. 2 shows a smartphone or smartphone case with an integrated microphone array.

FIG. 3 shows a smartphone case with an integrated microphone array and an auxiliary power supply.

FIG. 4 illustrates a smartphone case with a removable microphone array and battery module.

FIG. 5 illustrates a smartphone or smartphone case with an integrated microphone array having pivot-mounted legs and aerial.

FIG. 6 shows a smartphone or smartphone case according to FIG. 5 in a deployed configuration.

FIG. 7 shows a cross-section of an interface connector.

### DETAILED DESCRIPTION OF PREFERRED EMBODIMENTS

Before the present invention is described in further detail, it is to be understood that the invention is not limited to the particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

It must be noted that as used herein and in the appended claims, the singular forms “a”, “an”, and “the” include plural referents unless the context clearly dictates otherwise. For the sake of clarity, D/A and ND conversions and specification of hardware or software driven processing may not be specified if it is well understood by those of ordinary skill in the art. The scope of the disclosures should be understood to include analog processing and/or digital processing and hardware and/or software driven components.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates, which may need to be independently confirmed.

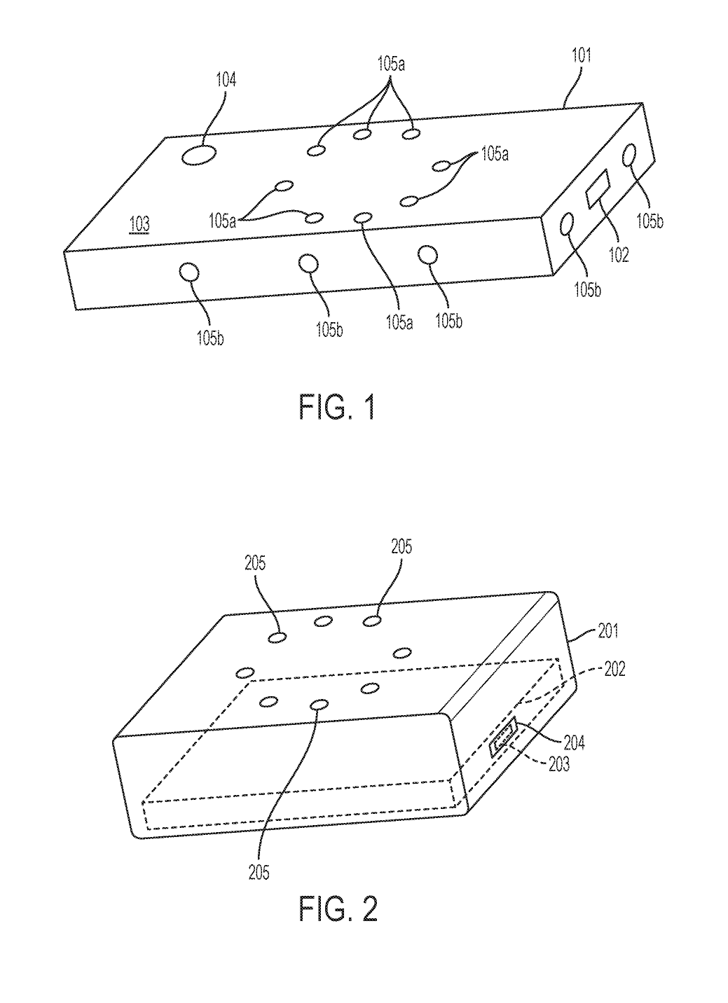

FIG. 1 shows a smartphone with an integrated microphone array. Smartphone 101 is illustrated. The smartphone 101 has a typical connection port 102. The smartphone 101 is illustrated face down with a back surface 103 facing up. Camera opening 104 is illustrated. Microphones 105A may be provided on the back surface 103 of the smartphone housing. According to an alternative embodiment, microphones 105B may be provided on lateral surface of the smartphone casing. According to a preferred configuration, three or more microphones 105 may be provided as a microphone array. The microphones may be linearly arranged. The microphones may also be arranged in a non-linear configuration. Arrangement in a non-linear configuration facilitates use of the microphone array to sense audio for the purpose of determining the direction of an audio source relative to the array and for beamforming and beam shaping. FIG. 1 illustrates eight microphone sensors 105A arranged in a circular or octagonal configuration. An embodiment with lateral side mounted microphones may exhibit three microphone elements 105B mounted in the sides of the smartphone housing and two microphones mounted on the top and bottom of the smartphone housing.

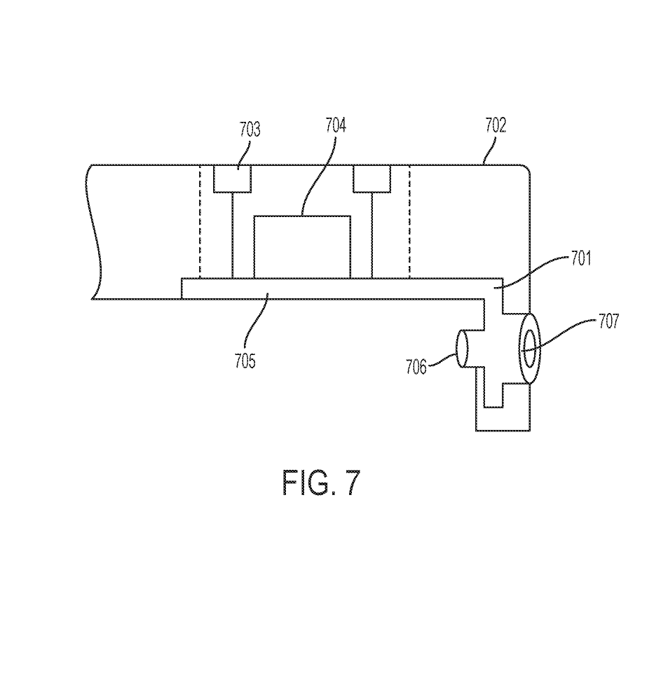

FIG. 2 shows an embodiment configured in a protective outer case 201 for a smartphone 202. A smartphone 202 typically has a port 203 serving as an electrical interface to smartphone 202. The smartphone case 201 may have an opening 204 to accommodate an interface connector, shown in FIG. 7. The case 201 may also be provided with openings as may be required to allow access to smartphone controls. The smartphone case 201 may be provided with three or more microphone elements 205. The microphone elements 205 may be connected in a microphone array. The wiring (not shown) for the microphones 205 may be routed in the microphone case 201 and connected to smartphone port 203. According to one embodiment, a smartphone case interface connector serves to connect the electrical elements of the case to the smartphone 202 through smartphone port 203 and to link an external interface connector to the smartphone port 203 and electrical elements of the smartphone case 201. The wiring for the microphone elements 205, and any necessary circuitry may be connected to through the interface connector, see FIG. 7.

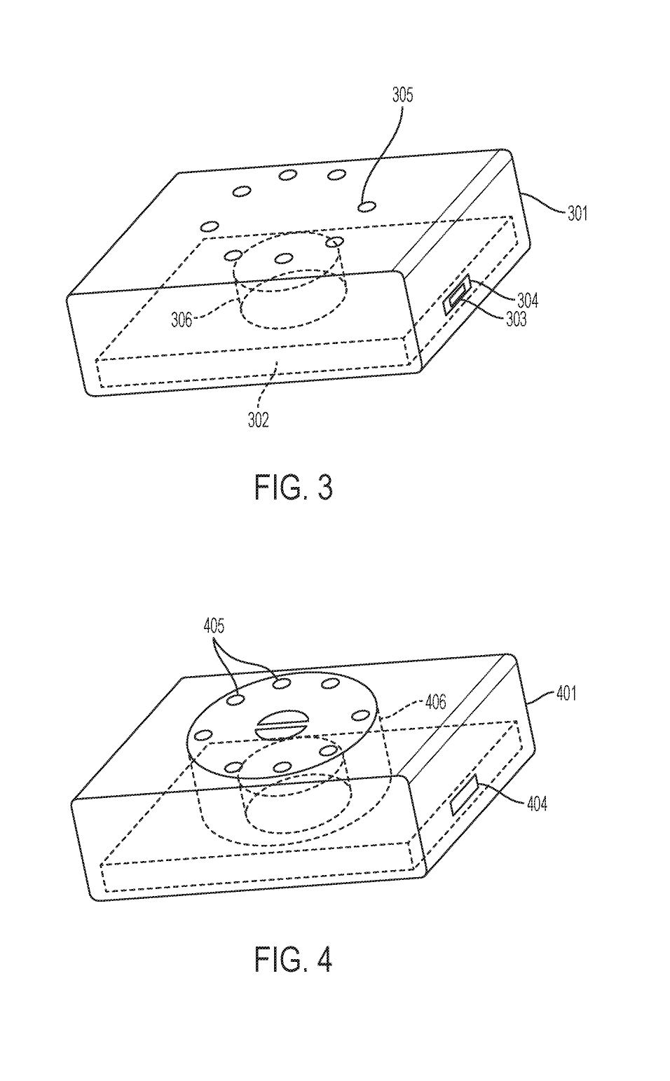

FIG. 3 shows an embodiment with an auxiliary power supply configured in a protective outer case 301 for a smartphone 302 with a port 303. The smartphone case 301 may have an opening 304 to accommodate an interface connector illustrated in FIG. 7. The case 301 may also be provided with openings as may be required to allow access to smartphone controls. The smartphone case 301 may be provided with three or more microphone elements 305. The microphone elements 305 may be connected in a microphone array. The wiring (not shown) for the microphones 305 may be routed in the microphone case 301 and connected to smartphone port 303. According to one embodiment, the smartphone case interface connector serves to connect the electrical elements of the case 301 to the smartphone 302 through port 303 and to link an external interface connector to the smartphone port 303. The wiring for the microphone elements, and any necessary circuitry may be connected to the link between the smartphone case port and the case connector mating with the smartphone shows a smartphone case 301 which includes the same essential elements as smartphone case as 201 (FIG. 2), but also includes an auxiliary battery 306. The auxiliary battery 306 may be connected to provide additional power to the smartphone and to power the microphone array and any circuitry included in the case.

FIG. 4 shows a smartphone case 401 substantially identical to the case shown in FIG. 3 but with a removable module 406 containing the microphone elements 405 of the microphone array and auxiliary battery. The module 406 may be provided with external contacts designed to establish a connection between wiring internal to the case and the module for the purpose of connecting the battery to the smartphone and/or charging the auxiliary battery. The contacts may mate with an interface connector, similar to that shown in FIG. 7. The smartphone case 401 may have an opening 404 to accommodate and interface connector that links the electrical elements of the case to the smartphone port and an external connector. The module 406 may be a charging station or a mounting hub for use of the microphone array in a location remote from the smartphone and/or smartphone housing.

The detachable module 406 allows for use as a “battery pack” to power components other than the smartphone and allows use as a modular microphone array.

The smartphone case may also be provided with wireless communication equipment such as a Bluetooth card transceiver for communications with the smartphone or other processing device.

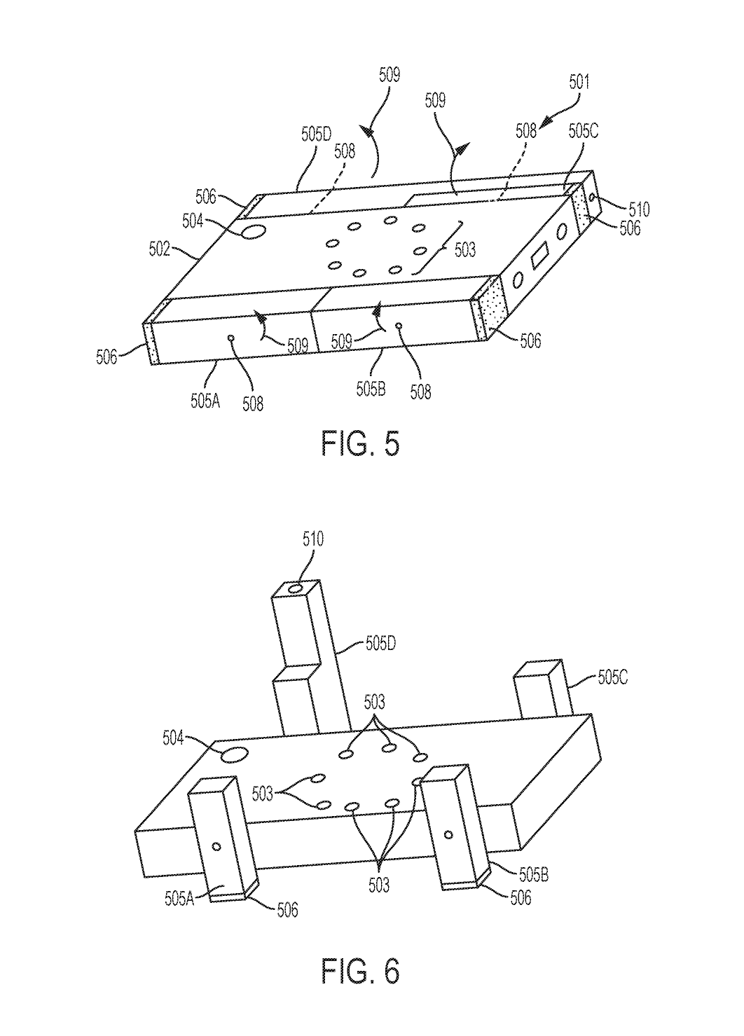

FIG. 5 illustrates a smartphone or smartphone case with an integrated microphone array having pivot mounted legs and aerial. Element 501 illustrated in FIG. 5 represents a smartphone or a smartphone case shell. The device of FIG. 5 includes a main body portion 502 provided with three or more microphone elements in a microphone array 503. The main body 502 may include an opening 504 for a camera. There are four legs 505A, 505B, 505C, and 505D. Each leg may be provided with a base 506. The base 506 may be of a resilient material and provide an anti-skid property and/or a vibration/noise damping or isolating property. Each leg may be mounted on pivot 508. FIG. 5 shows the device 501 in a closed configuration. FIG. 6 shows the device 501 in a deployed configuration. The same reference numerals are utilized for identical elements illustrated in FIGS. 5 and 6. Arrows 509 illustrate the rotation of each leg 505.

Legs 505A and 505B may be substantially similar in shape and height to each other. Leg 505D includes a microphone element 510. Microphone element 510 is elevated upon deployment of the legs 505D in order to provide for a multi-planar array configuration. Leg 505D as shown is longer than 505A, 505B, and 505C. Leg 505D and 505C are configured so that they may mate in the closed configuration yet permit elevated positioning of microphone element 510 in the deployed configuration. The multi-planar configuration array allows for audio source location in a three-dimensional vector as well as beam forming and beam shaping in three dimensions. The accuracy of location depends on the quality of the components, the processing power, and the spacing of the microphone array elements. If the application does not require the spacing established by the configuration illustrated in FIG. 6, the legs may all be the same height. An alternative structure for establishing sufficient elevation of a non-planar microphone element would be to provide a telescoping leg which may be extended in the deployed configuration to establish great spacing.

Three non-co-linear microphones in an array may define a plane. A microphone array that defines a plane may be utilized for source detection according to azimuth, but not according to elevation. At least one additional microphone 108 may be provided in order to permit source location in three-dimensional space. The microphone 108 and two other microphones define a second plane that intersects the first plane. The spatial relationship between the microphones defining the two planes is a factor, along with sensitivity, processing accuracy, and distance between the microphones that contributes to the ability to identify an audio source in a three-dimensional space.

FIG. 7 shows a cross-section of an interface connector 701 that may be used substantially in the form illustrated with the embodiments illustrated in FIGS. 2-4. The smartphone case 702 may be configured to accommodate the interface connector 701. The electrical elements of the smartphone case 702 such as directionally sensitive audio transducer or microphones/microphone arrays 703 and auxiliary battery or battery module 704 may be connected to a wiring support section 705 of the interface connector 701. The interface connector has and electrical interface connecting and internal connector 706, designed to mate with a smartphone port, the wiring to the electrical components 703, 704, and an external connector 707

The techniques, processes and apparatus described may be utilized to control operation of any device and conserve use of resources based on conditions detected or applicable to the device.

The invention is described in detail with respect to preferred embodiments, and it will now be apparent from the foregoing to those skilled in the art that changes and modifications may be made without departing from the invention in its broader aspects, and the invention, therefore, as defined in the claims, is intended to cover all such changes and modifications that fall within the true spirit of the invention.

Thus, specific apparatus for and methods of a portable microphone array have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A microphone array comprising:
a base associated with a mobile computing device;
three or more microphones mounted on said base; wherein said microphones are mounted in a configuration with a first microphone mounted in a position that is not co-linear with a second microphone and a third microphone; and
a fourth microphone mounted in a location that is not co-planar with said first microphone, said second microphone and said third microphone.

2. A microphone array according to claim 1 wherein said microphones are mounted on said base in a configuration where, for every angle of azimuth referenced from said microphone array from 0 degrees to 360 degrees, there are at least two microphones in said array which include the angle of azimuth within their field of sensitivity and are unobstructed by said base and user.

3. A microphone array according to claim 2 wherein said base is an outer housing of said mobile computing device.

4. A microphone array according to claim 2 wherein said base is a protective case configured to receive a mobile computing device.

5. A microphone array according to claim 4 further comprising an auxiliary power supply mounted in said protective case.

6. A microphone array according to claim 4 further comprising a detachable module mating with a housing of said protective case and wherein said microphones are mounted in said detachable module.

7. A microphone array according to claim 6 further comprising an auxiliary power supply mounted in said detachable module.

8. A microphone according to claim 1 wherein said microphones are mounted in a generally coplanar configuration.

9. A microphone array according to claim 8 further comprising an additional microphone mounted on a boom configured to position said additional microphone so that it is not coplanar with said three or more microphones.

10. A microphone array according to claim 9 wherein said additional microphone is mounted on a boom pivot mounted on said base.

11. A microphone array according to claim 9 wherein said additional microphone is mounted on a telescoping boom.

12. A microphone array according to claim 9 further comprising three or more legs pivot mounted on said base.

13. A microphone array according to claim 12 further comprising resilient material mounted on said legs.

14. A microphone array according to claim 13 wherein said resilient material is vibration damping.

15. An audio source location tracking and isolation system comprising:
a microphone array having three or more microphones;
a location processor responsive to said microphone array;
a beam-forming unit responsive to said microphone array; and
a beam steering unit responsive to said microphone array.

16. A microphone array comprising:
a base associated with a mobile computing device;
three or more microphones mounted on said base; wherein said microphones are mounted in a configuration with a first microphone mounted in a position that is not co-linear with a second microphone and a third microphone; and
wherein said base is a protective case configured to receive a mobile computing device.
